(19) United States
(12) Patent Application Publication
(10) Pub. No.: US 2010/0269708 A1
(43) Pub. Date: Oct. 28, 2010

(54) Cooking Utensil that is Cleaned Easily and Quickly

(76) Inventor: Feng-Hsin Huang, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/430,364

(22) Filed: Apr. 27, 2009

(51) Int. Cl. A47J 27/00

(52) U.S. Cl. 99/324; 220/573.1

(57) ABSTRACT

A cooking and baking utensil includes a main body and a silicone layer attached to the main body. The silicone layer includes a silicone and at least one heat conducting metallic member mixed with the silicone. Thus, the food will not be stuck on the silicone layer during the cooking process. In addition, the heat conducting metallic member of the silicone layer directly touches the surface of the food to increase the temperature of the food during the cooking process so that the food is slightly burned or scorched by the heat conducting metallic member to present a yellow color so as to enhance the outer appearance of the food. Further, the silicone of the silicone layer is mixed with an antibacterial so that the silicone layer has an antibacterial effect.

### BACKGROUND OF THE INVENTION

1. Field of the Invention

The present invention relates to a cooking and baking utensil and, more particularly, to a cooking and baking utensil, such as a cooking or baking pan, pot and the like.

2. Description of the Related Art

A conventional cooking and baking utensil, such as a cooking or baking pan, pot and the like, is used to cook or boil a food, such as meat, fishes, cake and the like. However, the inner surface of the cooking and baking utensil directly touches the food so that the food is easily stuck on the inner surface of the cooking and baking utensil during the cooking process, thereby causing inconvenience to a user when clearing the cooking and baking utensil after cooking. In addition, if the cooking and baking utensil is made of ceramic or glass, the cooking and baking utensil is easily broken due to hit or collision and falling down, thereby causing danger to the user.

### BRIEF SUMMARY OF THE INVENTION

The primary objective of the present invention is to provide a cooking and baking utensil that is cleaned easily and quickly and has an antibacterial effect.

In accordance with the present invention, there is provided a cooking and baking utensil, comprising a main body and a silicone layer attached to the main body. The main body has an inner surface and an outer surface. The silicone layer includes a silicone and at least one heat conducting metallic member located in and mixed with the silicone.

Preferably, the silicone layer is attached to the inner surface of the main body to cover the inner surface of the main body.

Alternatively, the silicone layer is enclosed around the inner surface and the outer surface of the main body.

Alternatively, the silicone layer is attached to the outer surface of the main body to cover the outer surface of the main body.

Preferably, the silicone layer is attached to the main body by spraying, rolling or dipping.

Preferably, the heat conducting metallic member of the silicone layer is iron, aluminum, stainless steel, titanium or carbon.

Preferably, the silicone of the silicone layer is mixed with an antibacterial so that the silicone layer has an antibacterial effect.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of a cooking and baking utensil in accordance with the preferred embodiment of the present invention.

FIG. 2 is a locally enlarged view of the cooking and baking utensil as shown in FIG. 1.

FIGS. 3-5 are front cross-sectional views showing fabrication of the cooking and baking utensil as shown in FIG. 1.

FIG. 6 is a partially front cross-sectional view of a cooking and baking utensil in accordance with another preferred embodiment of the present invention.

FIG. 7 is a front cross-sectional view of a cooking and baking utensil in accordance with another preferred embodiment of the present invention.

FIG. 8 is a locally enlarged view of the cooking and baking utensil as shown in FIG. 7.

### DETAILED DESCRIPTION OF THE INVENTION

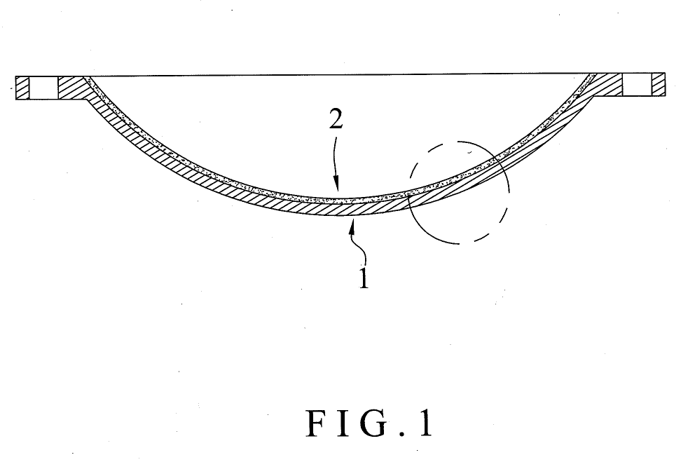

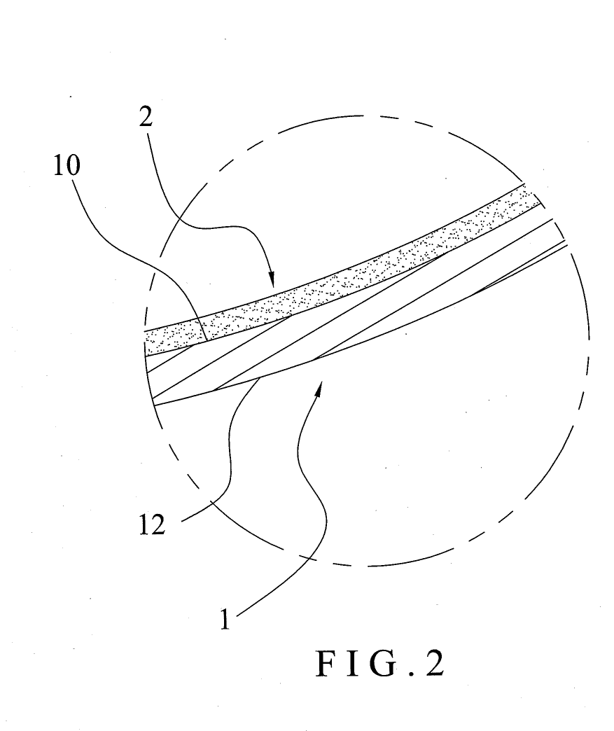

Referring to the drawings and initially to FIGS. 1 and 2, a cooking and baking utensil in accordance with the preferred embodiment of the present invention comprises a main body 1 and a silicone layer 2 attached to the main body 1 for placing a food.

The main body 1 is a pan or pot made of ceramic or glass. The main body 1 has an inner surface 10 and an outer surface 12. The inner surface 10 of the main body 1 has a concave cross-sectional profile, and the outer surface 12 of the main body 1 has a convex cross-sectional profile.

In the preferred embodiment of the present invention, the silicone layer 2 is attached to the inner surface 10 of the main body 1 to cover the inner surface 10 of the main body 1 so that the inner surface 10 of the main body 1 is fully encompassed by the silicone layer 2.

Alternatively, the silicone layer 2 is attached to the outer surface 12 of the main body 1 to cover the outer surface 12 of the main body 1 so that the outer surface 12 of the main body 1 is fully encompassed by the silicone layer 2. In such a manner, the silicone layer 2 is attached to the outer surface 12 of the main body 1 to provide a non slip effect, to prevent the main body 1 from being scratched and to prevent the main body 1 from being broken to pieces due to hit, collision or falling down.

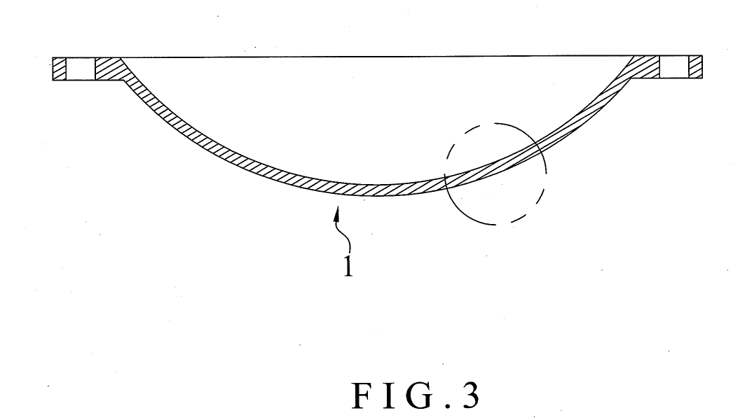

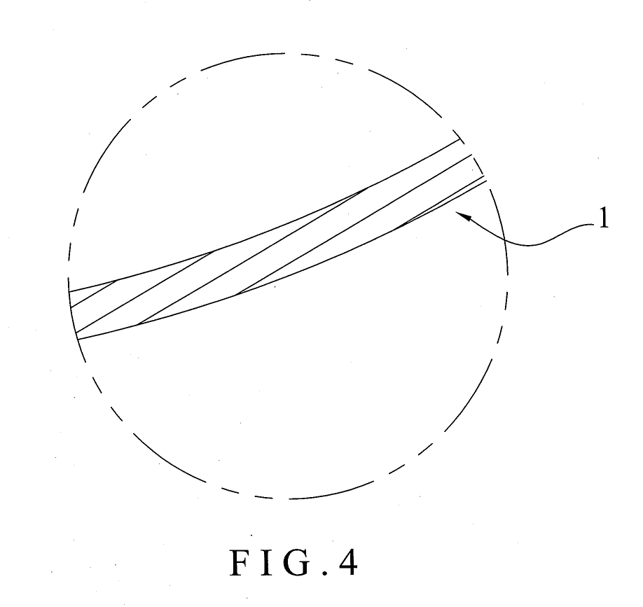

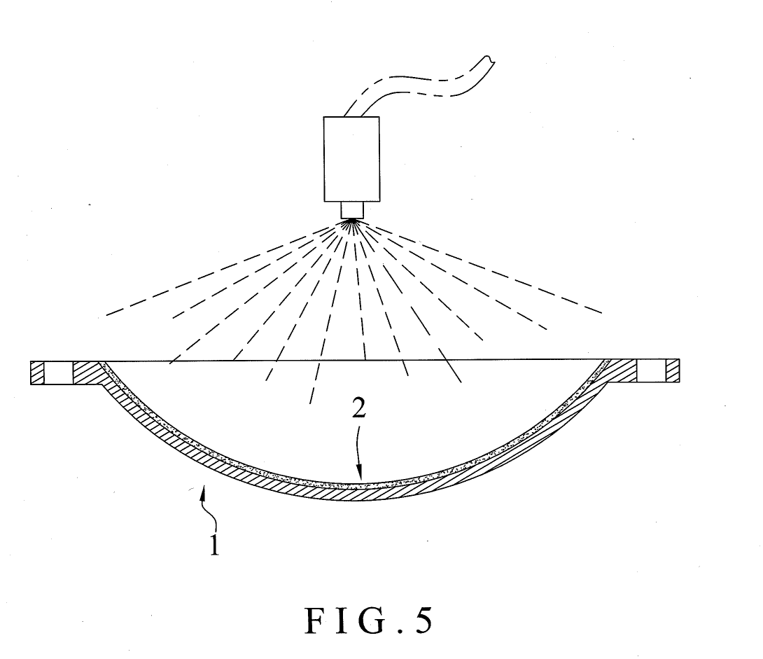

In fabrication of the cooking and baking utensil, referring to FIGS. 3-5 with reference to FIGS. 1 and 2, after the main body 1 is formed integrally as shown in FIGS. 3 and 4, the silicone layer 2 is attached to the main body 1 by spraying as shown in FIG. 5. Alternatively, the silicone layer 2 is attached to the main body 1 by spraying, rolling or dipping.

In practice, the heat from the main body 1 is transmitted through the silicone layer 2 to the food so as to cook the food. Thus, the silicone layer 2 will not produce smoke and will not burn the food during the cooking process so as to keep the flavor and nutrition of the food. In such a manner, the main body 1 is separated from the food by the silicone layer 2 so that the food will not be stuck on the silicone layer 2 during the cooking process, thereby facilitating a user clearing the cooking and baking utensil.

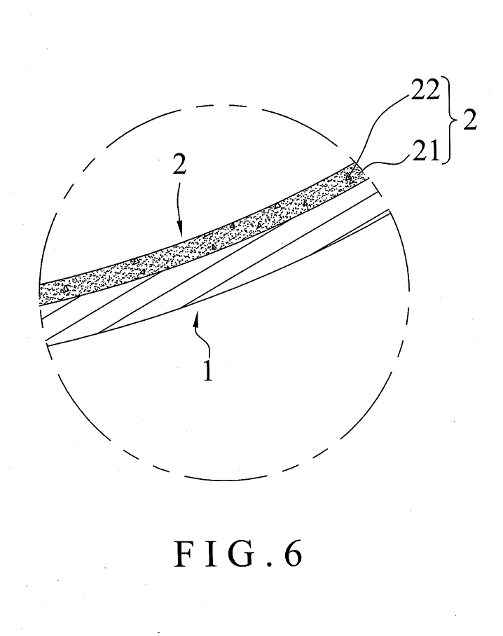

Referring to FIG. 6, the silicone layer 2 includes a silicone 21 and at least one heat conducting metallic member 22 located in and mixed with the silicone 21. Preferably, the heat conducting metallic member 22 of the silicone layer 2 is iron, aluminum, stainless steel, titanium, carbon and the like. In addition, the silicone 21 of the silicone layer 2 is mixed with an antibacterial so that the silicone layer 2 has an antibacterial effect. Preferably, the antibacterial in the silicone layer 2 consists of a zeolite (or boiling stone) of 95% to 99% and a silver of 1% to 5%. In addition, the antibacterial in the silicone layer 2 is mixed with and stirred by a silicone oil, and the ratio of the antibacterial and the silicone oil is from ten to ninety (10:90) to sixty to forty (60:40).

In such a manner, the silicone 21 of the silicone layer 2 is mixed with an antibacterial so that the silicone layer 2 has an antibacterial effect. In addition, the heat conducting metallic member 22 of the silicone layer 2 directly touches the surface of the food to increase the temperature of the food during the cooking process so that the food is slightly burned or scorched by provision of the heat conducting metallic member 22 of the silicone layer 2 to present a yellow color so as to enhance the outer appearance of the food.

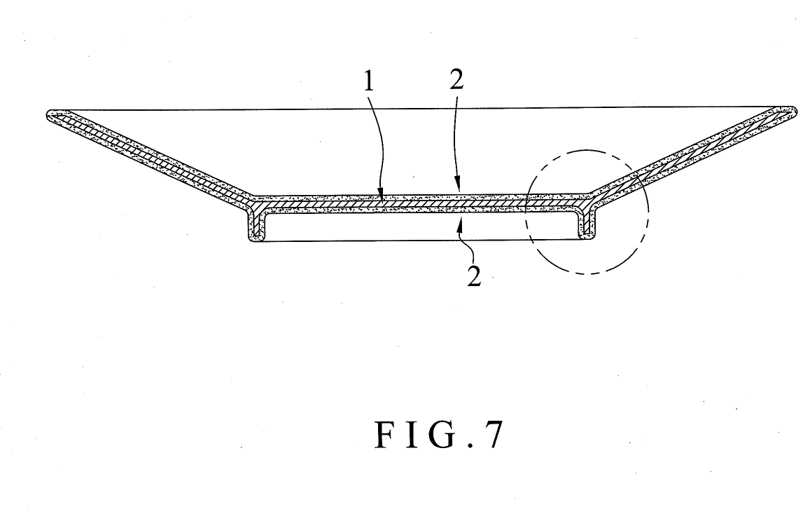

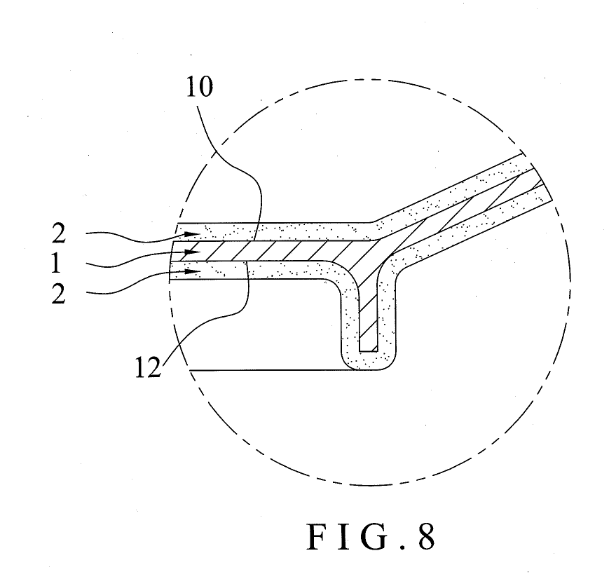

Referring to FIGS. 7 and 8, the silicone layer 2 is enclosed around the inner surface 10 and the outer surface 12 of the main body 1 so that the main body 1 is wholly encompassed by and fully hidden in the silicone layer 2.

Accordingly, the food will not be stuck on the silicone layer 2 during the cooking process, thereby facilitating a user clearing the cooking and baking utensil. In addition, the silicone 21 of the silicone layer 2 is mixed with an antibacterial so that the silicone layer 2 has an antibacterial effect to prevent from incurring bacterial, such as staphylococcus aureus, coli bacillus and the like. Further, the heat conducting metallic member 22 of the silicone layer 2 directly touches the surface of the food to increase the temperature of the food during the cooking process so that the food is slightly burned or scorched by provision of the heat conducting metallic member 22 of the silicone layer 2 to present a yellow color so as to enhance the outer appearance of the food. Further, the silicone layer 2 encompasses the whole surface of the main body 1 to provide a non skid effect and to prevent the main body 1 from being scratched. Further, the silicone layer 2 combines with the main body 1 so that even when the main body 1 is broken due to hit, collision or falling down, the broken main body 1 will not be separate or sputtered outwardly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cooking and baking utensil, comprising:
a main body;
a silicone layer attached to the main body;
wherein the silicone layer includes:
a silicone;
at least one heat conducting metallic member located in and mixed with the silicone;
the silicone of the silicone layer is mixed with an antibacterial.

2. The cooking and baking utensil of claim 1, wherein
the main body has an inner surface and an outer surface;
the silicone layer is attached to the inner surface of the main body to cover the inner surface of the main body.

3. The cooking and baking utensil of claim 1, wherein
the main body has an inner surface and an outer surface;
the silicone layer is enclosed around the inner surface and the outer surface of the main body.

4. The cooking and baking utensil of claim 3, wherein the main body is wholly encompassed by and fully hidden in the silicone layer.

5. The cooking and baking utensil of claim 2, wherein the inner surface of the main body is fully encompassed by the silicone layer.

6. The cooking and baking utensil of claim 1, wherein
the main body has an inner surface and an outer surface;
the silicone layer is attached to the outer surface of the main body to cover the outer surface of the main body.

7. The cooking and baking utensil of claim 6, wherein the outer surface of the main body is fully encompassed by the silicone layer.

8. The cooking and baking utensil of claim 1, wherein the silicone layer is attached to the main body by spraying.

9. The cooking and baking utensil of claim 1, wherein the silicone layer is attached to the main body by rolling.

10. The cooking and baking utensil of claim 1, wherein the silicone layer is attached to the main body by dipping.

11. The cooking and baking utensil of claim 1, wherein the heat conducting metallic member of the silicone layer is iron, aluminum, stainless steel, titanium or carbon.

12. The cooking and baking utensil of claim 1, wherein the antibacterial in the silicone layer consists of a zeolite of 95% to 99% and a silver of 1% to 5%.

13. The cooking and baking utensil of claim 12, wherein
the antibacterial in the silicone layer is mixed with and stirred by a silicone oil;
a ratio of the antibacterial and the silicone oil is from ten to ninety (10:90) to sixty to forty (60:40).

14. The cooking and baking utensil of claim 2, wherein
the inner surface of the main body has a concave cross-sectional profile;
the outer surface of the main body has a convex cross-sectional profile.
